(19) United States
(12) Patent Application Publication
(10) Pub. No.: US 2015/0031267 A1
(43) Pub. Date: Jan. 29, 2015

(54) METHOD AND DEVICE FOR ATTRACTING ANIMALS

(71) Applicant: Christopher Gerard Barrette, Auburn, NY (US)

(72) Inventor: Christopher Gerard Barrette, Auburn, NY (US)

(21) Appl. No.: 14/338,403

(22) Filed: Jul. 23, 2014

Related U.S. Application Data
(60) Provisional application No. 61/857,473, filed on Jul. 23, 2013.

(51) Int. Cl. A01M 31/00

(52) U.S. Cl. CPC A01M 31/004
USPC 446/202

(57) ABSTRACT

A game call device is disclosed that utilizes a tube to convey air (and, in some embodiments, sounds) emanating from a caller in a remote location to a game call at the other end of the tube. Some embodiments include other types of stimuli, such as optical stimuli, that can add to or enhance the attraction of animals.

### CROSS-REFERENCE TO RELATED APPLICATIONS

This application claims priority to U.S. provisional patent application No. 61/857,473 (filed Jul. 23, 2013), the content of which is hereby incorporated by reference.

### BACKGROUND OF THE INVENTION

This disclosure relates generally to game calling or attracting devices and, in one or more embodiments, to a device and method for attracting animals from a remote location using forced air, vocalizations, and/or visual stimuli.

Hunters, photographers and naturalists have been trying to draw animals close by use of calls, vocalizations and other stimuli for decades. While the types and methods of calls and vocalizations have improved over the years, there remains the problem inherent in calling animals. When a call is made, the animal is focused upon the caller's location more often than not increasing the chances of spooking the animal. For example, game calls can be operated by use of the mouth, mechanically with the hands, or by other means. The caller can also attempt to use concealment, such as within modern blinds, elevated stands, or camouflage clothing, but the sound still comes from within focusing attention on the source. Attempts to solve this problem include the use of remote speakers. However, the use of electronic devices may, for many types of hunting, be considered illegal or unethical.

### BRIEF DESCRIPTION OF THE INVENTION

Embodiments of the present disclosure addresses the problems noted above. Embodiments of the disclosed device utilize a tube to convey air (and, in some embodiments, sounds) emanating from a caller in a remote location to a game call at the other end of the tube. Some embodiments include other types of stimuli, such as visual stimuli, that can add to or enhance the attraction or focus of animals.

In one embodiment, the device is configured to allow the caller to be remotely located in an elevated tree stand. The tube is flexible and may comprise rubber, polyvinylchloride (PVC) or other compositions, unraveled in a manner to conceal the tube from the animals (such as being of a camouflage coloration). The tube can be secured to follow the contours of a tree stand, a tree, and/or ground terrain. The device can also comprise a game call at the end of the tube capable of creating the desired sound or vocalization.

In another embodiment, the device has a visual stimulus at the end of the tube to keep the animal's attention focused on the game call and away from the caller. Various commentators have reported on the visual acuity of animals such as the whitetail deer. See, e.g., New Insights Into Deer Vision (Drs. Gino D'Angelo and Karl V. Miller). By varying the color/spectrum of the visual stimulus, particularly at the distal end of the tube, the caller can further focus the animal's attention on the source of the sound or the visual stimulus emitted by the device.

This brief description is intended only to provide a brief overview of subject matter disclosed herein according to one or more illustrative embodiments, and does not serve as a guide to interpreting the claims or to define or limit the scope of the concepts recited herein, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a schematic depiction of an exemplary embodiment of a calling device with a game call located at a distal end;

FIG. 2 is a schematic depiction of another exemplary embodiment of a calling device with a game call located at a proximate end;

FIG. 3 is a schematic depiction of an exemplary embodiment of an extension mechanism for use with a calling device; and

FIG. 4 is a schematic depiction of an exemplary embodiment of a calling device with a game call and visual stimulus located at a distal end;

### DETAILED DESCRIPTION OF THE INVENTION

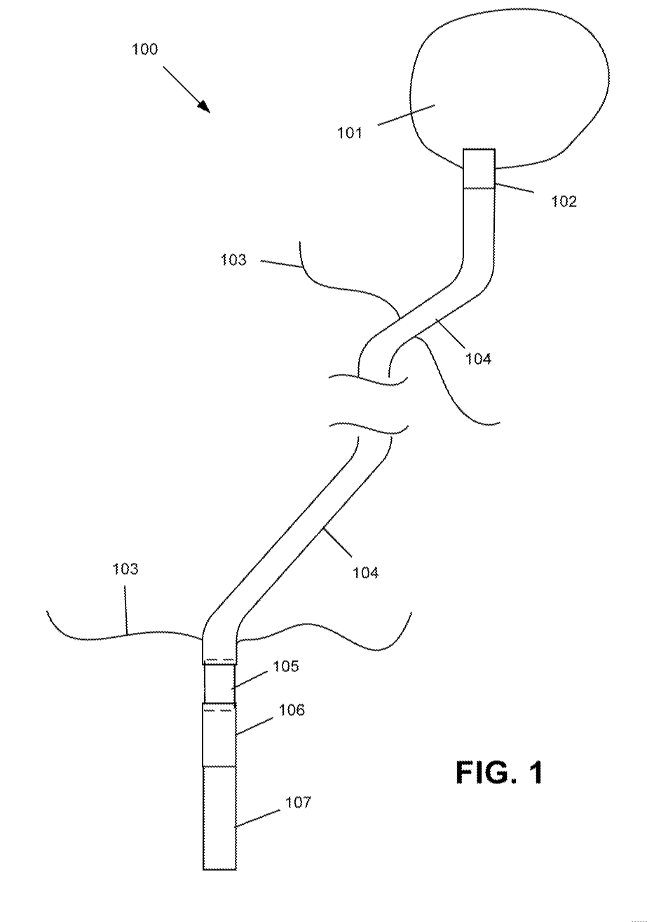

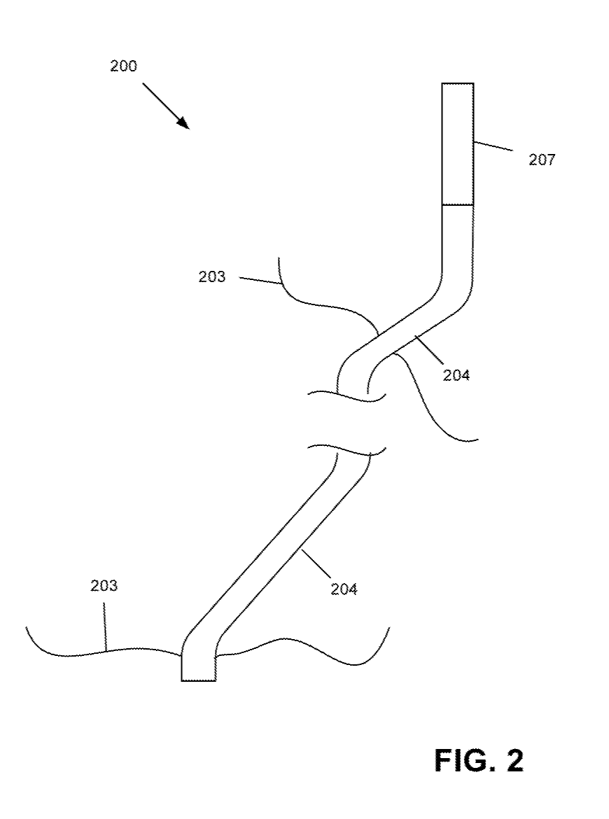

FIG. 1 is an illustrative representation of the components of exemplary embodiments of a calling device 100 comprising a necklace 101 and a mouth piece 102 located at a proximate end of a tube 104. In some embodiments, the necklace 101 is used to keep the mouthpiece 102 proximate the caller's mouth when the calling device 100 is not in use. The calling device 100 further comprises a junction tube 105, an adapter 106 and a game call 107 located at a distal end of the tube 104. One or more mounting fixtures 103 are also provided on the tube 104 to hold the tube 104 to a nearby environmental structure, such as a tree. In some embodiments the mounting fixtures 103 also provide a means to hold the tube 104 in a compacted (e.g. coiled) state. In the embodiment of FIG. 1, the game call 107 is shown on the distal end. In other embodiments (see FIG. 2), the game call is on the proximate end.

In use, the caller directs air and/or sounds into the tube 104. In one embodiment, the mouth piece 102 is used to facilitate this direction. The sounds may be a call generated by the caller's mouth and thereafter directed by the tube 104. In other embodiments, the caller directs air without sounds into the tube 104 and the air is conveyed to the game call 107. An off-the-shelf game call (e.g., an elk call, a deer call, a duck call, etc.) may be used as the game call 107.

The tube 104 has properties (e.g., length, material composition, color, etc.) as desired. The selection of such properties may coincide with, for example, the field conditions and/or target animal. This disclosure contemplates any number of attachment mechanism for connecting the mouthpiece 102 with the tube 104, such as a pressure connection, threading, etc. In one example, the attachment mechanism creates a seal (e.g., an airtight seal) that permits forced air and sound to be conveyed down the tube 104 to the game call 107.

The tube 104 is secured by the mounting fixtures 103, such as a string tie, to a tree stand, vegetation, or other structure, in order to camouflage or disguise the tube 104 so that it blends with the tube's surroundings and is not apparent to the animal. Additionally, the mounting fixtures 103 holds the game call 107 in a fixed location, thereby securing an audio/visual stimuli in the fixed location for attraction of or discovery by the animal.

In one embodiment, the tube 104 terminates at its connection to the junction tube 105, the adaptor 106 or the game call 107. The junction tube 105 provides a reducing connection that permits a relatively large tube 104 to be connected to a relatively small adaptor 106. The junction tube 105 may be, for example 1.5 inches long with a 0.5 inch internal diameter. The adaptor 106 functions as an airtight adapter between the tube 104 and the game call 107. In one embodiment, the adaptor 106 comprises a form fitting call ring made of soft foam for making a secure seal. Any suitable means of attachment may be used, such as a pressure connection, threading, or other means capable of maintaining air flow and/or sound emanating from the proximate end of the tube 104.

In one embodiment, the caller generates sound or air flow from the proximate end of the tube 104 of sufficient pressure and/or velocity to convey the air through the length of the tube 104, to the distal end of the tube 104, causing sound or other vocal stimuli to be projected from the distal end.

In one embodiment, the calling device 100 limits the sound generated by the caller at the proximate end of the tube 104, in order to prevent the animal from hearing the sound, and thereby betraying the call's location.

In one embodiment, the calling device 100 maximizes the sound being generated at, or emanating from the distal end of the tube, in order to focus the animal's attention on this location remote and apart from the caller.

In one embodiment, the calling device 100 adds further stimulation at the distal end of the tube, such as through a colored attachment, colored call, a scent, or some other attractant, to further focus the animal's attention on the distal end of the tube 104 or game call 107 and away from the caller.

FIG. 2 is an illustrative representation of the components of exemplary embodiments of a calling device 200. The calling device 200 comprises a tube 204 with a game call 207 at an air input end. One or more mounting fixtures 203 are provided to hold the tube 204 to a nearby environmental structure, such as a tree. In use, the caller directs air into the game call 207 and the tube 204 conveys the sound produced by the game call 207 to an air output end of the tube 204. In some embodiments, additional attachments, such as mouthpieces, necklaces, and the like may be used in conjunction with the embodiment of FIG. 2.

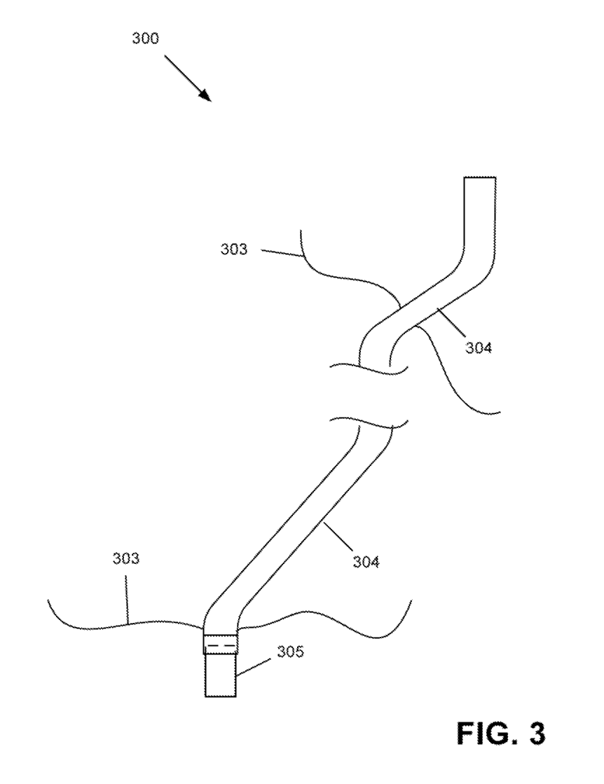

FIG. 3 depicts an extension tube 300 for use with the disclosed calling device. The extension tube 300 comprises one or more mounting fixtures 303 to hold a tube 304 to a nearby environmental structure, such as a tree. A junction tube 305 may be inserted into an end of the extension tube 300 and, in this fashion, connect to a tube such as tube 104 or tube 204. By connecting one or more extension tubes 300 in series, the caller can move the distal end of a calling device to a predetermined location, regardless of distance.

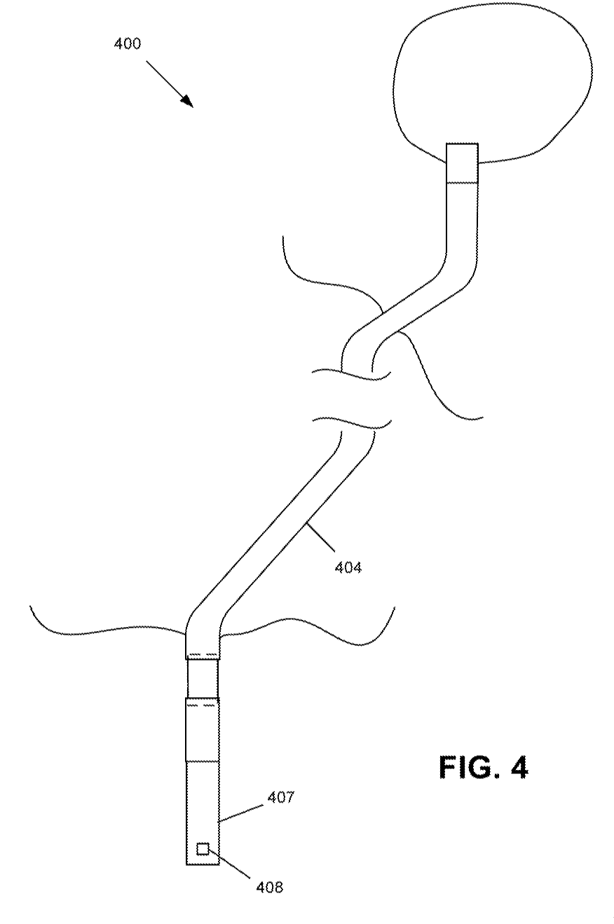

FIG. 4 depicts the distal end of a calling device 400 where a game call 407 or other attractant can be inserted into a tube 404. A visual stimuli 408 is attached to the game call 407. The visual stimuli 408 may be a light source that emits light in the electromagnetic spectrum. The wavelength of emitted light is selected to be optimal for the animal being attracted. This causes the animal's attention to be further focused on the distal end of the calling device, thereby diverting the animal's attention from the caller. The visual stimuli 408 can be generated simply by the color or benign reflection of the device, or by the use of electronics, such as light emitting diode (LED) lighting. The latter could be triggered remotely or be constant. In one embodiment, the visual stimuli 408 is a light source that is sensitive to sound such that the light source is triggered to simultaneously appear only when the audio stimulus of the game call 407 is activated.

Generally, the tubes should have a length to move the distal end of the calling device to a sufficiently distant location that the call may remain concealed during use. In one embodiment, the tubes are flexible tubes with a length of at least twenty feet. In another embodiment, multiple tubes are joined together to extend the total length of the calling device.

The embodiments are inclusive of combinations of the aspects described herein. References to a particular aspect and the like refer to features that are present in at least one aspect of the embodiments. Separate references to an aspect or particular aspects or the like do not necessarily refer to the same aspect or aspects; however, such aspects are not mutually exclusive, unless so indicated or as are readily apparent to one of skill in the art. The use of singular or plural in referring to method or methods and the like is not limiting. The word “or” is used in this disclosure in a non-exclusive sense, unless otherwise explicitly noted.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A game calling device for use in attracting animals, the game calling device comprising:
a tube having a proximate end and a distal end;
a mouth piece coupled to the proximate end, the mouth piece configured to transmit an air flow generated by a caller into the proximate end, through the tube and toward the distal end of the tube;
a game call in communication with the tube such that the airflow generated by the caller exits the distal end of the tube and enters the game call, thereby causing the game call to generate a sound.

2. The game calling device as recited in claim 1, wherein the tube is flexible and has a length of at least about twenty feet.

3. The game calling device as recited in claim 1, wherein a junction tube is coupled with the distal end of the tube.

4. The game calling device as recited in claim 3, wherein an adaptor is coupled with the junction tube with a first airtight seal.

5. The game calling device as recited in claim 4, wherein the game call is coupled with the adaptor with a second airtight seal.

6. The game calling device as recited in claim 3, wherein an extension tube is coupled with the junction tube with a first airtight seal.

7. The game calling device as recited in claim 6, wherein a second junction tube is coupled with the extension tube with a second airtight seal.

8. The game calling device as recited in claim 7, wherein an adaptor is coupled with the second junction tube with a third airtight seal.

9. The game calling device as recited in claim 8, wherein the game call is coupled with the adaptor with a fourth airtight seal.

10. The game calling device as recited in claim 1, further comprising at least one mounting fixture coupled with the tube configured to securely attach the tube to an environmental structure.

11. A game calling device for use in attracting animals, the game calling device comprising:
a tube having an air input end and an air output end, the air input end configured to transmit an air flow generated by a caller through the tube and toward the air output end of the tube;
a game call in communication with the tube such that the airflow generated by the caller enters the game call, thereby causing the game call to generate a sound, the game call being disposed at the air output end of the tube; and
a visual stimulus device located proximate the game call.

12. The game calling device as recited in claim 11, wherein the game call is configured to reflect predetermined wavelengths of light from the electro-magnetic spectrum, the predetermined wavelengths being selected to attract a predetermined animal.

13. The game calling device as recited in claim 11, wherein the visual stimulus comprises a light source proximate the distal end.

14. The game calling device as recited in claim 13, wherein the light source is configured to turn on when the game call generates the sound and the light source is configured to turn off when the game call stops generating the sound.

15. The game calling device as recited in claim 12, wherein the predetermined wavelengths are selected to be within a visual acuity of the predetermined animal.

16. The game calling device as recited in claim 11, wherein the tube further comprises one or more mounting fixtures to hold the tube to an environmental structure.

17. A method of attracting animals using a game calling device, the method comprising steps of:
attaching a game calling device to an environmental structure, the game calling device comprising:
a tube having a proximate end and a distal end;
a mouth piece coupled to the proximate end, the mouth piece configured to transmit an air flow generated by a caller into the proximate end, through the tube and toward the distal end of the tube;
a game call in communication with the tube such that the airflow generated by the caller exits the distal end of the tube and enters the game call, thereby causing the game call to generate a sound;
a light source located proximate the game call wherein the light source is configured to turn on when the game call generates the sound and the light is configured to turn off when the game call stops generating the sound;
extending the tube such that the air input end of the tube is spaced from the air output end to permit the caller to be concealed;
passing air from the caller into the air input end such that the game call is actuated to produce the sound, the sound causing the light source to turn on;
stopping the passing of air, the step of stopping causing the light source to turn off.

18. The method as recited in claim 17, wherein the tube is flexible and has a length of at least about twenty feet.
